(19) United States
(12) Patent Application Publication
(10) Pub. No.: US 2013/0311258 A1
(43) Pub. Date: Nov. 21, 2013

(54) DIFFERENTIAL DEALS IN A THEME GROUP

(71) Applicants: Piyush Kumar Srivastava, Bangalore (IN); Ashootosh Chand, Bangalore (IN)

(72) Inventors: Piyush Kumar Srivastava, Bangalore (IN); Ashootosh Chand, Bangalore (IN)

(73) Assignee: YAHOO! INC., Sunnyvale, CA (US)

(21) Appl. No.: 13/473,337

(22) Filed: May 16, 2012

(51) Int. Cl. G06Q 30/02

(52) U.S. Cl. 705/14.16; 705/14.39; 705/14.2

(57) ABSTRACT

Techniques are provided for offering a deal to a group of users, and for determining differential discounts for the users of the group that participate in the deal. A deal is offered to users of a group of users formed in association with a corresponding topic. Each user of the group is enabled to selectively accept the deal. The deal is confirmed with a plurality of users of the group that accepted the deal. Discounts for the deal are differentially assigned to the plurality of users based on at least one parameter such that at least two users that accepted the deal have discounts that are different from each other.

### BACKGROUND OF THE INVENTION

1. Field of the Invention

The present invention relates to online deals and incentives.

2. Background

For many years, customers have been able to shop for products and services.

Traditionally, a customer has been able to purchase a product or service from a merchant. The merchant may occasionally offer discounts on their products and/or services. Such discounts may benefit customers with lower prices, and may benefit merchants by enabling increased sales volumes, enabling excess inventory to be reduced, and providing further benefits.

In recent years, the Internet has provided a new medium for customers to purchase products and services from merchants. For example, thousands of electronic commerce websites such as amazon.com, provided by Amazon.com, Inc. of Seattle, Wash., and ebay.com, provided by eBay Inc. of San Jose, Calif., have been established that sell products and services over the Internet. The availability of products and services for sale over the Internet has made shopping more convenient for customers and enabled merchants to reach larger numbers of customers.

Some websites have recently been provided online that provide coupons for discounted products and services to groups of users. Examples of such websites, referred to as “deal sites,” include www.groupon.com provided by Groupon, Inc. of Chicago, Ill. and livingsocial.com provided by LivingSocial Inc. of Washington, D.C. Some of these deal sites provide coupons that are activated if a predetermined minimum number of persons sign up for a particular deal. For instance, a discounted price for a product or service may be offered to users. If a predetermined number of the users sign up for the offer, then the deal becomes available to all of the users. If the predetermined number of the users does not sign up for the offer, the offer is retracted and is not available to any of the users.

Such deal sites have disadvantages. For example, such deal sites currently target users with deals that are not relevant to the users, or are based on basic user characteristics such as demographics or city-level locations. Users receive emails and SMS (short message service) spam continuously from these deal sites, which they monitor in the hopes that a relevant deal may come by.

Furthermore, deals are currently written in a very generic manner, such that every user receives the same offer, no matter how much a particular deal matters to the user. This leaves a lot of money on the table for merchants, which either do not participate in deals or end up providing too much discount in their deals.

Still further, currently there is no simple mechanism for merchants to predict reliably how many users are likely to subscribe to a particular deal. As a result, the cut-off size for a deal is decided based solely on the merchant's own evaluation of this uncertainty.

### BRIEF SUMMARY OF THE INVENTION

Various approaches are described herein for, among other things, forming groups of users, offering deals to groups of users, and determining differential discounts for users of a group that accept a deal. Groups of users may be formed in association with a selected topic of interest to the group. Deals may be offered to users of such a group. A deal may be selected to be directed to a particular group because the deal may be considered to be of interest to persons interested in that group's topic. Users of the group that accept the deal may have discounts provided to them that are different from each other, and that are determined based on various parameters.

In one method implementation, a deal is offered to users of a group of users, the group formed in association with a corresponding topic. Each user of the group is enabled to selectively accept the deal. The deal is confirmed with a plurality of users of the group that accepted the deal. Discounts for the deal are differentially assigned to the plurality of users based on at least one parameter such that at least two users of the plurality of users that accepted the deal have discounts for the deal that are different from each other.

In one aspect, a discount may be assigned to a user that accepted the deal based on a position of the user in a hierarchical tree of users of the group.

In another aspect, a discount may be assigned to a user that accepted the deal based on a participation score for the user that indicates how actively the user participates in the group.

In another aspect, a discount may be assigned to a user that accepted the deal based on a cumulative participation score for a sub-tree of users that were directly and indirectly invited by the user to the group.

In another aspect, a baseline discount value is assigned to each user that accepted the deal based on a number of users in the group.

In still another aspect, a discount may be assigned to a user that accepted the deal based on a review score for the user. The review score may be determined based on one or more reviews provided by the user on one or more deals previously offered to the group.

In a system implementation, a differential deal offering system is provided. The differential deal offering system includes a discount offering engine and a differential discount determiner. The discount offering engine offers a deal to users of a group of users formed in association with a corresponding topic, enables each user of the group to selectively accept the deal, and confirms the deal with a plurality of users of the group that accepted the deal. The differential discount determiner differentially assigns discounts for the deal to the plurality of users based on at least one parameter such that at least two users of the plurality of users that accepted the deal have discounts for the deal that are different from each other.

In one aspect, the differential discount determiner includes a tree position-based discount determiner. The tree position-based discount determiner assigns a discount to a user that accepted the deal based on a position of the user in a hierarchical tree of users of the group

In another aspect, the differential discount determiner includes a user participation score-based discount determiner and a participation score determiner. The participation score determiner determines a participation score for a user that accepted the deal. The user participation score-based discount determiner assigns a discount to the user based on the participation score.

In another aspect, the differential discount determiner includes a sub-tree participation score-based discount determiner and a participation score determiner. The sub-tree participation score-based discount determiner determines for a user that accepted the deal one or more users in a sub-tree of users that includes users directly and indirectly invited by the user to the group. The participation score determiner determines a participation score for each user in the sub-tree of users to determine a plurality of participation scores. The sub-tree participation score-based discount determiner determines a cumulative participation score for the sub-tree of users based on the plurality of participation scores, and assigns a discount to the user corresponding to the cumulative participation score.

In another aspect, the differential discount determiner includes a group-based discount determiner that assigns a baseline discount value to each user of a group based on a number of users in the group.

In another aspect, the differential discount determiner includes a review-based discount determiner that assigns a discount to a user that accepted the deal based on a review score for the user.

Computer program products are also described herein that enable groups of users to be formed in association with a topic, enable deals to be offered to a user group, and enable differential discounts to be determined for users of a group, as well as enabling further embodiments described herein.

Further features and advantages of the disclosed technologies, as well as the structure and operation of various embodiments, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the present invention and, together with the description, further serve to explain the principles involved and to enable a person skilled in the relevant art(s) to make and use the disclosed technologies.

FIG. 1 shows a block diagram of a communication system in which differential deals may be offered to user groups, according to an example embodiment.

FIG. 2 shows a flowchart providing a process for enabling a group of users to be configured and managed, according to an example embodiment.

FIG. 3 shows a block diagram of a group management system, according to an example embodiment.

FIG. 4 shows a block diagram of a user interface for managing and accessing a user group, according to an example embodiment.

FIG. 5 shows a flowchart providing a process for offering a differential deal to a group of users, according to an example embodiment.

FIG. 6 shows a block diagram of a differential deal offering system, according to an example embodiment.

FIG. 7 shows a block diagram of an offer message being displayed, according to an example embodiment.

FIG. 8 shows a block diagram of a differential discount determiner, according to an example embodiment.

FIG. 9 shows a process for assigning a discount to a user based on a position of the user in a user invitation hierarchy, according to an example embodiment.

FIG. 10 shows a hierarchical tree that is a representative of a chain of user invitations to a user group, according to an example embodiment.

FIG. 11 shows a flowchart providing a process for determining a discount for a user based on a position of the user in the group hierarchy, according to an example embodiment.

FIG. 12 shows a flowchart providing a process for assigning a discount to a user based on a participation score, according to an example embodiment.

FIG. 13 shows a flowchart providing a process for assigning a discount to a user based on a sub-tree of users in the group hierarchy directly and indirectly invited by the user to the group, according to an example embodiment.

FIG. 14 shows a process for assigning a discount to users in a group based on a size of the group, according to an example embodiment.

FIG. 15 shows a flowchart providing a process for assigning a discount to a user based on reviews provided by the user, according to an example embodiment.

FIG. 16 is a block diagram of a computer in which embodiments may be implemented.

The features and advantages of the disclosed technologies will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### I. Introduction

The following detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the art to implement such feature, structure, or characteristic in connection with other embodiments whether or not explicitly described.

Numerous exemplary embodiments of the present invention are described as follows. It is noted that any section/subsection headings provided herein are not intended to be limiting. Embodiments are described throughout this document, and any type of embodiment may be included under any section/subsection. Furthermore, disclosed embodiments may be combined with each other in any manner.

### II. Example Embodiments

A deal is an offer of a financial discount, rebate, coupon, or other incentive for purchasing a product and/or a service (or multiple products and/or services) that may be accepted by a customer. A deal is an example of a commercial incentive, which is an incentive (e.g., financial discounts, rebates, etc.) that may be provided by merchants to encourage customers to purchase products and/or services.

Embodiments are described herein targeting deals to users in user groups that are formed based on interests/topics or other attributes. As such, embodiments enable deals to be offered users that are more likely to be interested in the deals, as opposed to current techniques that target users indiscriminately. Furthermore, in an embodiment, users of a group that decide to accept a deal may be provided with differential discounts. According to differential discounts, different users in the group may receive different discount values, based on one or more parameters such as a level of activity in the group by the user, a number of users invited to the group by the user, etc. Such embodiments can create incentives for users to participate more actively in group activities, such as creating/consuming group-related content, providing comments to the group, providing reviews/ratings, providing photos, organizing online events for the group, etc. Such embodiments also incentivize users to expand the group by inviting more users, creating a tree-like user hierarchy indicating which user invited which other user. Embodiments incentivize users to invite users, causing their “sub-trees” in the group-hierarchy to grow, and contributing to the overall success of the theme-based group.

Such embodiments have advantages over current deal offering techniques. For instance, deal sites, such as www.groupon.com provided by Groupon, Inc. of Chicago, Ill. and livingsocial.com provided by LivingSocial Inc. of Washington, D.C., provide coupons that are activated if a predetermined minimum number of persons sign up for a particular deal. If a predetermined number of the users sign up for the offer, then the deal becomes available to all of the users. If the predetermined number of the users does not sign up for the offer, the offer is retracted and is not available to any of the users.

However, such deal sites currently target users with deals that are not relevant to the users, or are based on basic parameters like demographics or city-level locations. Users receive emails and SMS (short message service) spam continuously from these deal sites, which they monitor in the hopes that a relevant deal may come by. Embodiments overcome this disadvantage, because the interests of target users are better known because such interests are indicated by the active participation of the users in theme-based groups to which deals may be directed.

Furthermore, deals are currently written in a very generic manner, such that everyone receives the same offer, no matter how much a particular deal matters to the user. This leaves a lot of money on the table for merchants, which either do not participate in deals or end up providing too much discount. In contrast, in embodiments, a user may be known to be more likely to take part in a particular deal for a product/service due to their membership in a particular group. As such, a merchant may offer a lower discount to that user while still being able to strike the deal with that user.

Still further, currently there is no simple mechanism for merchants to predict reliably how many users are likely to subscribe to a particular deal. As a result, the cut-off size for a deal to be confirmed is decided based solely on the merchant's own evaluation of this uncertainty. In embodiments, the group size and group activity level may be determined, and may provide an indication of user groups that are more interested in a particular deal than other user groups, and better indicating a number of users likely to partake in the deal, thereby providing improved predictability.

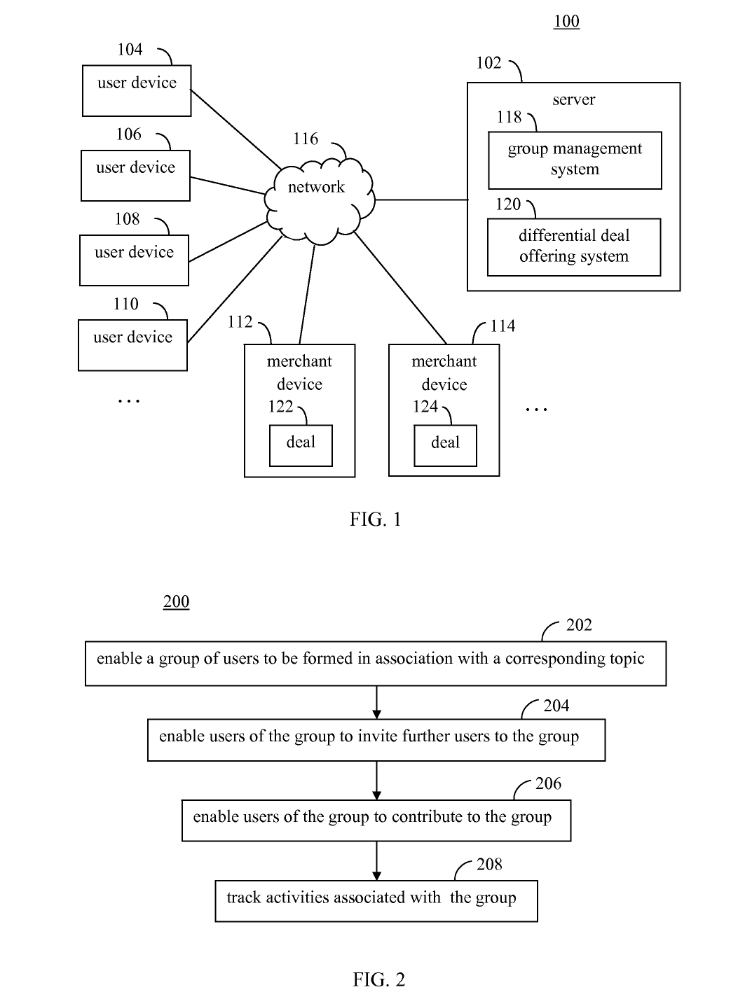

Embodiments may be implemented in a variety of environments. For instance, FIG. 1 shows a block diagram of a communication system 100 in which differential deals may be offered to user groups, according to an example embodiment. Environment 100 is shown for purposes of illustration, and embodiments may be implemented in other environments, as would be apparent to persons skilled in the relevant art(s) from the teachings herein. As shown in FIG. 1, system 100 includes a server 102, first-fourth user devices 104, 106, 108, and 110, first and second merchant devices 112 and 114, and a network 116. System 100 is described as follows.

User devices 104, 106, 108, and 110 and merchant devices 112 and 114 may each be any type of stationary or mobile computing device, including a desktop computer (e.g., a personal computer, etc.), a mobile computer or computing device (e.g., a Palm® device, a RIM Blackberry® device, a personal digital assistant (PDA), a laptop computer, a notebook computer, a tablet computer (e.g., an Apple iPad™), a netbook, etc.), a smart phone (e.g., an Apple iPhone, a Google Android™ phone, a Microsoft Windows® phone, etc.), or other type of computing device. Although four user devices are shown and two merchant devices are shown in FIG. 1, any number of user devices and merchant devices may be present, including tens, hundreds, thousands, and even greater numbers of user devices and merchant devices.

Server 102 may be implemented in one or more computer systems, including one or more servers, which may be any type of computing device described herein or otherwise known that is capable of enabling the corresponding functionality described herein.

Server 102, user devices 104, 106, 108, and 110, and merchant devices 112 and 114 are communicatively coupled with each other through network 116. Network 116 may be a LAN (local area network), a WAN (wide area network), or any combination of networks, such as the Internet. Server 102, user devices 104, 106, 108, and 110, and merchant devices 112 and 114 are each coupled with network 116 through a respective communication link. The communication links may each include wired and/or wireless links. Examples of such communication links include IEEE 802.11 wireless LAN (WLAN) wireless links, Worldwide Interoperability for Microwave Access (Wi-MAX) links, cellular network links, wireless personal area network (PAN) links (e.g., Bluetooth™ links), Ethernet links, USB (universal serial bus) links, etc.

Network 116 may include one or more routers, hubs, switches, bridges, etc., used to connect devices/networks and/or to forward data (e.g., data packets). In embodiments, network 116 may include the Internet and/or an intranet. Network 116 may enable RF (radio frequency) or wireless type communication via one or more network access technologies, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, or the like.

The Internet refers to a decentralized global network of networks. The Internet includes LANs, WANs, wireless networks, or long haul public networks that, for example, allow signal packets to be communicated between LANs. Signal packets may be communicated between nodes of a network, such as, for example, to one or more sites employing a local network address. A signal packet may, for example, be communicated over the Internet from a user site via an access node coupled to the Internet. Likewise, a signal packet may be forwarded via network nodes to a target site coupled to the network via a network access node, for example. A signal packet communicated via the Internet may, for example, be routed via a path of gateways, servers, etc. that may route the signal packet in accordance with a target address and availability of a network path to the target address.

When signals are transmitted in signal packets in network 116, such signal packets may be compatible with or compliant with one or more protocols. Signaling formats or protocols employed may include, for example, TCP/IP, UDP, DECnet, NetBEUI, IPX, Appletalk, or the like. Example versions of the Internet Protocol (IP) may include IPv4 or IPv6.

Server 102 is a server that manages user groups and serves deals to users. As shown in FIG. 1, server 102 includes a group management system 118 and a differential deal offering system 120. Group management system 118 enables users of user devices 104, 106, 108, and 110 to configure and manage user groups. For instance, group management system 118 may enable a user of user device 104 to define a group based on a particular topic, to add users to the group, to define one or more mechanisms for users of the group to communicate with each other, and to perform other group related setup functions. Furthermore, group management system 118 may enable users of a group at user devices 104, 106, 108, and 110 to participate in the group, such as by inviting other users to the group, sharing content with the group, etc.

Differential deal offering system 120 enables merchants, such as merchants at merchant devices 112 and 114, to provide deals to be offered by differential deal offering system 120. For instance, a first merchant associated with merchant device 112 may provide a first deal 122 to differential deal offering system 120 to offer to users, and a second merchant associated with merchant device 114 may provide a second deal 124 to differential deal offering system 120 to offer to users. Furthermore, differential deal offering system 120 offers the provided deals to users, such as users at user devices 104, 106, 108, and 110. In embodiments, differential deal offering system 120 may calculate differential discounts for users that participate in a deal, such that different users participating in the same deal may receive different discounts from each other.

Example embodiments for group management system 118 and differential deal offering system 120, and further embodiments, are described in the following subsections.

### A. Example Embodiments for Forming a User Group Based on a Topic

As described above, in embodiments, a group of users may be formed. A topic (also referred to as a theme) for the group may be defined, and users that are interested in the topic may decide to join the group. In this manner, groups of users having common interests and/or attributes may be formed that may be offered deals in a more targeted manner, rather than merely offering deals to largely unrelated users, as in current deal offering techniques.

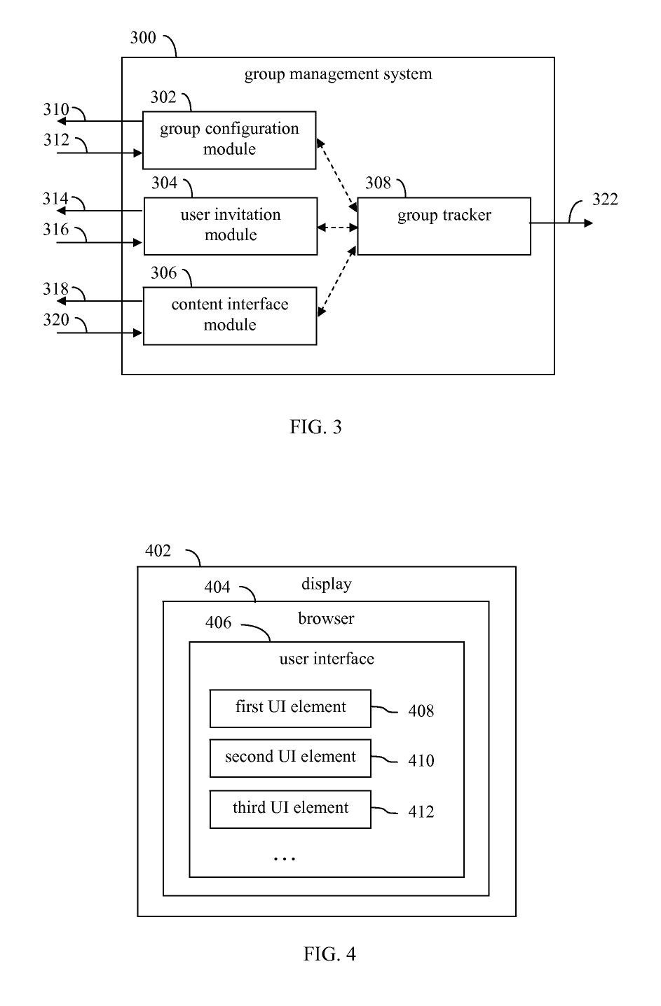

For instance, FIG. 2 shows a flowchart 200 providing a process for enabling a group of users to be configured and managed, according to an example embodiment. In an embodiment, group management system 118 of FIG. 1 may operate according to flowchart 200. For purposes of illustration, flowchart 200 is described as follows with respect to FIG. 3. FIG. 3 shows a block diagram of a group management system 300, according to an example embodiment. As shown in FIG. 3, group management system 300 includes a group configuration module 302, a user invitation module 304, a content interface module 306, and a group tracker 308. Further structural and operational embodiments will be apparent to persons skilled in the relevant art(s) based on the following description of flowchart 200 and group management system 300. Note that the steps of flowchart 200 do not need to be performed in the order shown, in all embodiments.

Flowchart 200 begins with step 202. In step 202, a group of users is enabled to be formed in association with a corresponding topic. For instance, in an embodiment, group configuration module 302 of FIG. 3 may be configured to enable a group of users to be formed. As shown in FIG. 3, group configuration module 302 may generate a group configuration user interface 310. Group configuration user interface 310 may be interacted with by users to configure groups, such as by providing an initial set of one or more original group members (founders) and defining a topic associated with the group. As shown in FIG. 3, group configuration module 302 may receive group configuration information 312, which includes group configuration information (e.g., initial members, group topic, etc.) provided by the users to group configuration user interface 310.

Group configuration user interface 310 can have any suitable configuration, in embodiments. For instance, group configuration user interface 310 may be a textual interface or graphical user interface (GUI) that enables a user to input configuration information. FIG. 4 shows a block diagram of a user interface 406, according to an example embodiment. In an embodiment, group configuration module 302 of FIG. 3 may generate user interface 406 as an example of group configuration user interface 310.

As shown in FIG. 4, user interface 406 may be displayed by a display 402 to a user at a user device, such as user device 104 of FIG. 1. In such an example, information to generate user interface 406 may be transmitted to user device 104 through network 116 from server 102. The user may interact with user interface 406 to configure a user group. For instance, user interface 406 may provide one or more user interface elements, such as first-third UI (user interface) elements 408, 410, and 412 that enable the user to configure the group. Examples of UI elements 408, 410, and 412 include text entry boxes, check boxes, pull down menus, etc., and any number of UI elements may be present. The user may be enabled to input various group configuration information using the present UI elements, such as being enabled to input a name for the group, an indication of a topic of interest of the group (e.g., an object category such as classic automobiles, an entity such as the San Francisco Giants baseball team, a person such as Tom Cruise, an abstract concept such as Science Fiction, etc.), an indication or configuration of a website for the group, a configuration of techniques for group members to communicate/provide content (e.g., email, chat, instant messaging, by social network messaging, etc.), and/or further group information.

User interface 406 may be displayed in any form. For instance, in the example of FIG. 4, user interface 406 may be provided in a web page displayed by a browser 404. Examples of browser 404 include Internet Explorer®, developed by Microsoft Corp. of Redmond, Wash., Mozilla Firefox®, developed by Mozilla Corp. of Mountain View, Calif., Safari®, developed by Apple Inc. of Cupertino, Calif., and Google® Chrome of Mountain View, Calif., etc. In other embodiments, user interface 406 may be provided by another type of application (e.g., a desktop application, a mobile “app”, etc.), or may be provided in another manner.

Referring back to FIG. 2, in step 204, users of the group are enabled to invite further users to the group. Once a group is established, user invitation module 304 of FIG. 3 may be configured to enable users of the group to invite other users to the group. For instance, as shown in FIG. 3, user invitation module 304 may generate a user invitation interface 314. User invitation interface 314 may be interacted with by users in a group to invite further users, such as by enabling the users to generate an invitation message that is transmitted by user invitation module 304 that is transmitted to the invited users (e.g., by email, by text message, by social network message, etc.). A user that receives the message may be enabled to accept or decline the invitation. As shown in FIG. 3, user invitation module 304 may receive invitation responses 316, which identifies one or more users that have accepted invitations from users in a particular group to join the group.

User invitation interface 314 can have any suitable configuration, in embodiments, including a textual interface and/or GUI that enables a user to configure user invitations. For instance, in an embodiment, user invitation interface 314 may have a configuration similar to user interface 406 of FIG. 4, having one or more UI elements for enabling a user to invite new group members. User invitation interface 314 may be provided in a browser (e.g., as shown for user interface 406 in FIG. 4), in a window of another application (e.g., a desktop application, a mobile “app”, etc.), or may be provided in another manner.

Referring back to FIG. 2, in step 206, users of the group are enabled to contribute to the group. In an embodiment, content interface module 306 of FIG. 3 may be configured to enable users of the group to contribute content to the group. For instance, as shown in FIG. 3, content interface module 306 may generate a content interface 318. Content interface 318 may be interacted with by users in a group to provide content to the group, including information regarding the topic of interest of the group. For instance, content interface 318 may enable users to provide content such as textual information (e.g., in the form of a blog, etc.), may host a chat room/message forum, may enable users to upload image files, video files, and/or audio files, etc. Content interface 318 may be a web page, such as a home page or other web page of a website associated with the group, or may be another type of interface. As shown in FIG. 3, content interface module 306 may receive content 320 that is input to content interface 318.

Content interface 318 can have any suitable configuration, in embodiments, including a textual interface and/or GUI that enables a user to configure user invitations. For instance, in an embodiment, content interface 318 may have a configuration similar to user interface 406 of FIG. 4, having one or more UI elements for enabling a user to provide content. Content interface 318 may be provided in a browser (e.g., as shown for user interface 406 in FIG. 4), in a window of another application (e.g., a desktop application, a mobile “app”, etc.), or may be provided in another manner.

Referring back to FIG. 2, in step 208, activities associated with the group are tracked. In an embodiment, group tracker 308 of FIG. 3 may be configured to track information regarding one or more groups. For instance, as shown in FIG. 3, group tracker 308 may be coupled to group configuration module 302, user invitation module 304, and content interface module 306. For a particular group, group tracker 308 may track the information described above as provided at group configuration module 302, such as the group name, group topic, website (e.g., uniform resource locator (URL)), initial members, and further information for one or more groups. As such, group tracker 308 may track a plurality of groups. Group tracker 308 may track the information described above as provided at user invitation module 304, such as new users that accepted invitations to join the group, including tracking the identity of the new user and the identity of the user who invited the new user. Furthermore, group tracker 308 may track the information described above as provided at content interface module 306, such as content provided to the group and an identity of the users who provided the content.

As shown in FIG. 3, group tracker 308 may output tracked information 308, which may include any of the information tracked by group tracker 308. Group tracker 308 may store tracking information 322 in storage associated with group management system 300 (not shown in FIG. 3).

In this manner, or in other ways, groups may be formed that are hosted online, and that are associated with topics. The following subsection describes example embodiment for directing deals to such groups, including differential deals.

### B. Example Embodiments for Offering Deals to Groups of Users

As described above, in embodiments, groups of users having common interests and/or attributes may be offered deals in a targeted manner. In an embodiment, such deals may result in discounts that have different values for different users in a group. For instance, such differential discounts may be determined based on participation levels of users in the group, the influence of different users of the group in determining the size of the group, and/or on other parameters/factors. In this manner, various incentives are provided to users of the group, such as incentives to participate more actively in group activities, to increase the size of the group, and to perform other functions that enhance the overall success of the group.

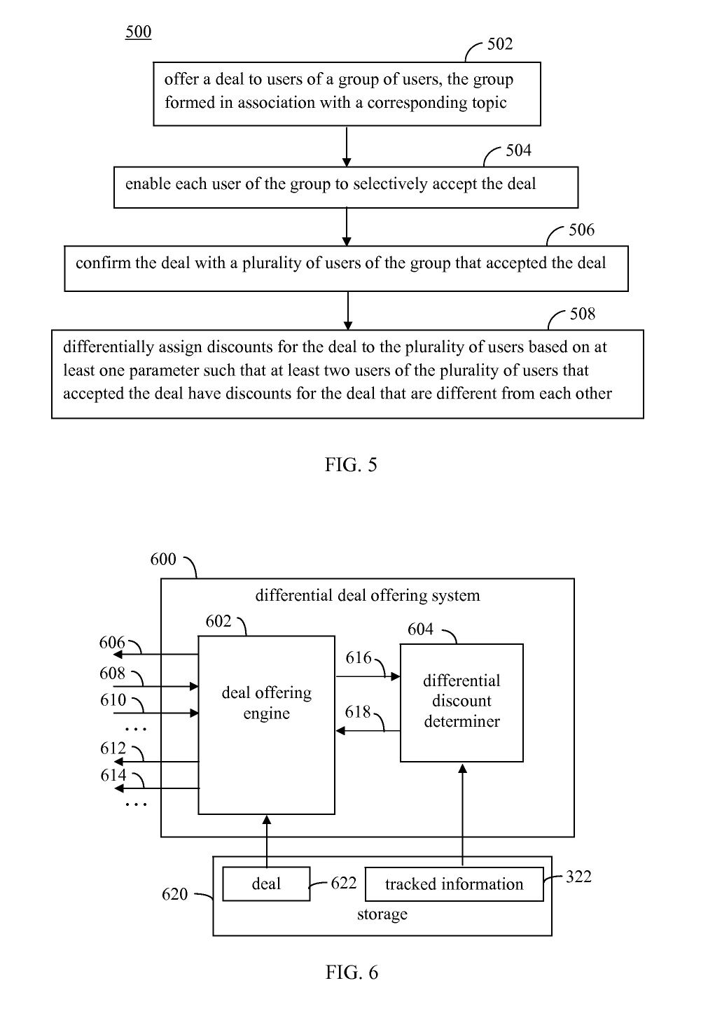

FIG. 5 shows a flowchart 500 providing a process for offering a differential deal to a group of users, according to an example embodiment. In an embodiment, differential deal offering system 120 of FIG. 1 may operate according to flowchart 500. For purposes of illustration, flowchart 500 is described as follows with respect to FIG. 6. FIG. 6 shows a block diagram of a differential deal offering system 600, according to an example embodiment. As shown in FIG. 6, differential deal offering system 600 includes a deal offering engine 602 and a differential discount determiner 604. Differential deal offering system 600 is an example embodiment of differential deal offering system 120 of FIG. 1. Further structural and operational embodiments will be apparent to persons skilled in the relevant art(s) based on the following description of flowchart 500 and differential deal offering system 600. Note that the steps of flowchart 500 do not need to be performed in the order shown, in all embodiments.

Flowchart 500 begins with step 502. In step 502, a deal is offered to users of a group of users, the group formed in association with a corresponding topic. For example, in an embodiment, deal offering engine 602 of FIG. 6 may be configured to offer a deal to users of a group. As shown in FIG. 6, deal offering engine 602 may access a deal 622 in storage 620 (e.g., where any number of deals, such as deals 122 and 124 of FIG. 1, may be stored). Deal offering engine 602 receives deal 622, and offers the deal described in deal 622 to users of a particular group.

For instance, in an embodiment, a merchant (e.g., a merchant associated with one of merchant devices 112 and 114 of FIG. 1 that provided deal 622) may have researched a plurality of groups managed by group management system 118 of server 102 in FIG. 1. By accessing tracking information 322, the merchant may have accessed topics of interest associated with the groups managed by group management system 118 to determine which user group-topic pairs were available. For instance, the merchant may access a user interface provided by group management system 118 (e.g., similar to user interface 406 described above) to research groups and their associated topics (as indicated in tracking information 322). The merchant may have selected a group having an associated topic that is aligned with deal 622 such that the users of the group may be more interested in participating in deal 622 than would users of the general population. For instance, the merchant may have decided that users of a group having a topic of “classic automobiles” may be interested in having the opportunity to participate in deal 622, which may be a deal for 0% APR (annual percentage rate) financing for a new or used Ford automobile. As such, the merchant may select the “classic automobiles” group of users to receive deal 622.

As shown in FIG. 6, deal offering engine 602 may transmit deal 622 to users in one or more communications, such as an offer message 606, transmitted to the users of the user group. Offer message 606 may be transmitted as a single message or as multiple messages, including being displayed in a web page (e.g., a web page of the group) displayed in a browser, being a message displayed by an application (e.g., by an application executing in a desktop computer, a web application hosted in a browser, an “app” at a mobile device, etc.), or being transmitted in one or more of an email message, a text message, a “tweet”, a social network message, and/or in another manner. User devices (e.g., user devices 104, 106, 108, and 110 of FIG. 1) of the users may each receive and display offer message 606 so that the users may decide whether to participate in deal 622

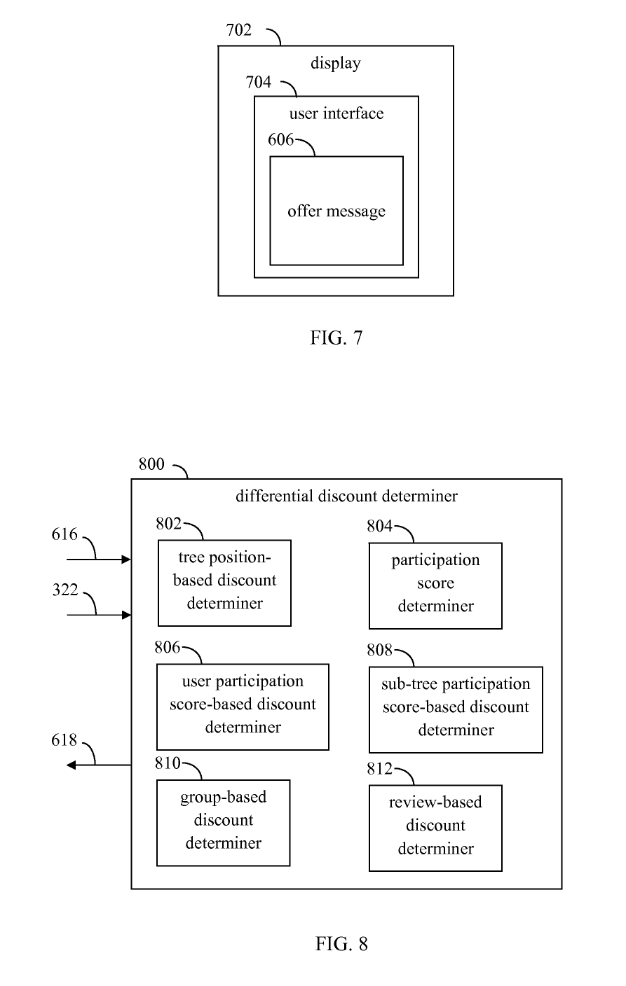

For instance, FIG. 7 shows a block diagram of a display 702 at a user device used to display offer message 606 to a corresponding user, according to an example embodiment. As shown in FIG. 7, display 702 displays a user interface 704, which may be a textual interface or GUI, such as a user interface provided by an email tool, by an application, by a web browser, by a text message interface, etc. User interface 704 displays offer message 606, including displaying information associated with offer message 606 from deal 622, such as one or more of a deal name, an indication of one or more products and/or services that may be purchased, an indication of original prices for the product(s)/service(s), an indication of discount prices and/or coupons for the products)/service(s), an indication of any threshold values associated with causing deal 622 to be confirmed, an indication of an expiration date for deal 622, and/or further deal information. A user of the user device may interact with user interface 704 to provide identifying information for the user (if not already known by differential deal offering system 600 of FIG. 6 as part of a group membership, etc.), and to indicate whether or not the user will participate in the deal provided by offer message 606.

Referring back to FIG. 5, in step 504, each user of the group is enabled to selectively accept the deal. In an embodiment, deal offering engine 602 of FIG. 6 may be configured to receive responses from users that indicate whether they have selected to accept the deal. For instance, as described above, offer message 606 may be provided to users of the group, and the users may interact with offer message 606 (e.g., clicking on an “accept” button, a “buy” button, etc.) or otherwise act to participate in deal 622. As shown in FIG. 6, deal offering engine 602 may receive responses 608, 610, and potentially further responses to offer message 606 from users in one or more communications. Responses 608 and 610 indicate that corresponding users of the group desire to participate in the offer.

In step 506, the deal is confirmed with a plurality of users of the group that accepted the deal. In an embodiment, deal offering engine 602 of FIG. 6 is configured to confirm a deal based on one or more factors, such as when a threshold value number of users have selected to accept the deal (in responses 608, 610, etc.), when a predetermined amount of time has elapsed since the deal was initiated, and/or based on another factor. If deal 622 is determined to be confirmed, deal offering engine 602 may store an indication in storage 620 that deal 622 is confirmed, and/or may store the confirmed indication elsewhere. Furthermore, deal offering engine 602 may notify each user that provided one of responses 608, 610, etc. that the deal is confirmed. Deal offering engine 602 may notify the users in any manner, including one or more of an email, a text message, a “tweet”, an indication in a web page, an indication in a member account of each user, an indication provided by an application, an indication in user interface 704 (FIG. 7), and/or in another manner.

In step 508, discounts for the deal are differentially assigned to the plurality of users based on at least one parameter such that at least two users of the plurality of users that accepted the deal have discounts for the deal that are different from each other. Differential discount determiner 604 of FIG. 6 may be configured to calculate discount values for one or more of the users that accepted deal 622. In an embodiment, different discount values may be calculated for different users that accepted the same offer of deal 622. Such different discount values may be used for various reasons, including incentivizing/rewarding user participation in the group, enabling merchants to provide users determined to be more important with greater discounts, and enabling merchants to not over-discount products/services with respect to users likely to accept less discounting.

In an embodiment, differential discount determiner 604 determines a discount each user that accepted a deal based on one or more parameters. Examples of such parameters include a position of the user in a user hierarchy of the group, a participation score for the user (indicating how active the user is in the group), a cumulative or aggregate participation score for users that were directly and indirectly invited by the user to the group, a size of the group, and a quantity and/or quality of reviews and/or other content provided by the user to the group. These parameters are provided as illustrative embodiments, and are not intended to be limiting. Discounts may be determined by differential discount determiner 604 based on further parameters that would become apparent to persons skilled in the relevant art(s) from the teachings herein.

As shown in FIG. 6, differential discount determiner 604 receives a user discount request 616 from deal offering engine 616. User discount request 616 identifies the users that accepted a deal that was confirmed. Deal offering engine 616 provides user discount request 616 to differential discount determiner 604 in order to determine the discounts to be provided to the identified users. As shown in FIG. 6, differential discount determiner 604 receives tracking information 322. Differential discount determiner 604 may determine the discounts to be provided to the users based at least in part based on tracking information 322. Differential discount determiner 604 determines the discounts, and generates determined discounts 618, which indicates the discounts to be provided to each of the users. Deal offering engine 602 receives determined discounts 618, and transmits the determined discounts to each of the users as user discounts 612, 614, etc.

Differential discounts may be calculated in numerous ways and may be calculated based on various parameters by differential discount determiner 604. For instance, FIG. 8 shows a block diagram of a differential discount determiner 800, according to an example embodiment. Differential discount determiner 800 is an example embodiment of differential discount determiner 604. As shown in FIG. 8, differential discount determiner 800 includes a tree position-based discount determiner 802, a participation score determiner 804, a user participation score-based discount determiner 806, a sub-tree participation score-based discount determiner 808, a group-based discount determiner 810, and a review-based discount determiner 812. Each of these components of differential discount determiner 800 enables user discounts to be determined based on one or more corresponding parameters. Such parameters may include group-related parameters (e.g., group size, the topic of the group, etc.), parameters that indicate a relationship between the user and the group (e.g., a position of the user in a group hierarchy, an activity level of the user in the group, the users invited to the group by the user, reviews and/or content provided by the user to the group, etc.), and further types of parameters. Any one or more of these components of differential discount determiner 800 may be present or not present in embodiments. These components of differential discount determiner 800 are described in the following subsections.

### 1. Example Embodiments for Determining Discounts According to Hierarchical Position

In an embodiment, tree position-based discount determiner 802 may be present in differential discount determiner 800. When present, tree position-based discount determiner 802 is configured to calculate discounts for users of a group that are participating in a deal based on the position of the users in a hierarchical tree representation of the group. For instance, as described above, users of a group may invite further users to the group. The users that are invited to the group may invite still further users to the group. As such, a hierarchy of users in the group may be formed as a tree that has branches indicating chains of user invitations. Tree position-based discount determiner 802 may be configured to calculate discounts for users of a group that are participating in a deal based on the position of the users in such a hierarchical tree representing user invitations.

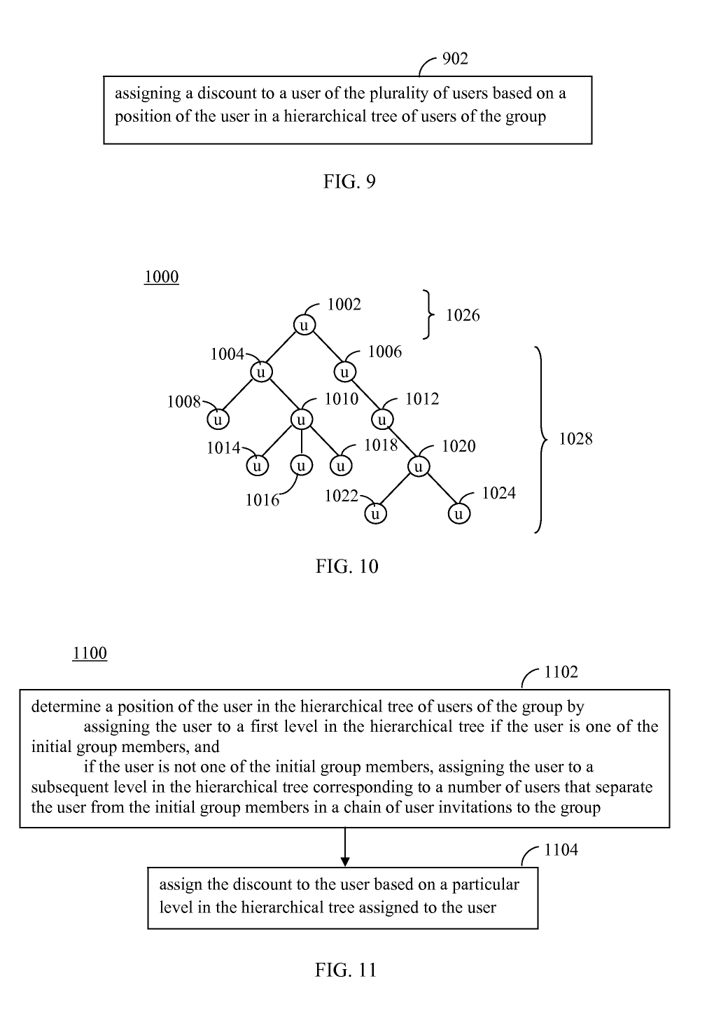

For instance, in an embodiment, tree position-based discount determiner 802 may be configured to calculate a discount for each user according to a process 902 shown in FIG. 9. According to process 902, a discount is assigned to a user of the plurality of users based on a position of the user in a hierarchical tree of users of the group.

For example, FIG. 10 shows a hierarchical tree 1000 that is a representative of a chain of user invitations to a user group, according to an example embodiment. FIG. 10 shows a plurality of users 1002, 1004, 1006, 1008, 1010, 1012, 1014, 1016, 1018, 1020, 1022, and 1024 that are members of a group, and that each accepted a same deal. Users 1002, 1004, 1006, 1008, 1010, 1012, 1014, 1016, 1018, 1020, 1022 may be all of the members of the group (if all members accepted the deal), or may be a subset of the members of the group. Users 1002, 1004, 1006, 1008, 1010, 1012, 1014, 1016, 1018, 1020, 1022, and 1024 are shown in FIG. 10 in hierarchical tree 1000 arranged to represent a chain of invitations to the group. Hierarchical tree 1000 includes one or more users (user 1002 in this example) that are initial group members 1026, and includes a remaining set 1028 of one or more users (users 1004, 1006, 1008, 1010, 1012, 1014, 1016, 1018, 1020, 1022, and 1024) that does not include the users in initial group members 1026. Each user of remaining set 1028 was invited to the group by another user of the group, as indicated in FIG. 10.

For instance, as shown in hierarchical tree 1000, user 1002, which was the initial group member, invited users 1004 and 1006 to the group, as indicated by corresponding branches between user 1002 and 1004 and between user 1002 and user 1006. User 1004 invited users 1008 and 1010 to the group, as indicated by corresponding branches between user 1004 and 1008 and between user 1004 and user 1010. User 1006 invited user 1012 to the group, as indicated by a branch between user 1006 and user 1012. User 1008 did not invite any users to the group (that accepted the deal). User 1010 invited users 1014, 1016, and 1018 to the group, as indicated by three corresponding branches. User 1012 invited user 1020 to the group, as indicated by a branch between user 1012 and user 1020. User 1020 invited users 1022 and 1024 to the group, as indicated by two corresponding branches.

Tree position-based discount determiner 802 may receive user discount request 616 and tracking information 322 (e.g., from storage 620). Tracked information 332 may indicate which users of the group are original group members, and which users of the group invited which other users of the group. In response to user discount request 616, tree position-based discount determiner 802 may calculate a discount for each user in hierarchical tree 1000 by assigning a discount to each user based on a position of the user in hierarchical tree 1000. For instance, tree position-based discount determiner 802 may perform process 902 of FIG. 9 according to FIG. 11. FIG. 11 shows a flowchart 1100 providing a process for determining a discount for a user based on a position of the user in the group hierarchy, according to an example embodiment.

In step 1102 of flowchart 1100, a position of the user in the hierarchical tree of users of the group is determined. In an embodiment, the position of the user is determined by assigning the user to a first level in the hierarchical tree if the user is one of the initial group members, and if the user is not one of the initial group members, assigning the user to a subsequent level in the hierarchical tree corresponding to a number of users that separate the user from the initial group members in a chain of user invitations to the group. A position in the hierarchical tree of the group for each user may be determined in this manner by tree position-based discount determiner 802 using the invitation information provided in tracking information 322.

For instance, referring to the example of FIG. 10, user 1002 is the initial group member. As such, because user 1002 is an initial group member, user 1002 is assigned to the first level in hierarchical tree 1000 by tree position-based discount determiner 802. Users 1004 and 1006 were invited to the group by user 1002, and are therefore each separated from user 1002 by one user invitation. As such, users 1004 and 1006 are assigned to the second level in hierarchical tree 1000. Users 1008, 1010, and 1012 were invited to the group by users in the second level, and are therefore each separated from user 1002 by a chain of two user invitations. As such, users 1008, 1010, and 1012 are assigned to the third level in hierarchical tree 1000. Users 1008, 1010, and 1012 were invited to the group by users in the second level, and are therefore each separated from user 1002 by a chain of three user invitations. As such, users 1014, 1016, 1018, and 1020 are assigned to the fourth level in hierarchical tree 1000. Users 1022 and 1024 were invited to the group by user 1020 in the third level, and are therefore each separated from user 1002 by a chain of four user invitations. As such, users 1022 and 1024 are assigned to the fifth level in hierarchical tree 1000.

Referring back to FIG. 11, in step 1104, the discount is assigned to the user based on a particular level in the hierarchical tree assigned to the user. In an embodiment, tree position-based discount determiner 802 may assign a discount to each user in the hierarchical tree according the level assigned to the user in step 1102.

For instance, in an embodiment, a highest discount may be assigned by tree position-based discount determiner 802 to the user if the particular level assigned to the user is the first level (highest level) If the particular level assigned to the user is not the first level, a discount may be assigned by tree position-based discount determiner 802 to the user that is lower than the highest discount by an amount proportional to a separation of the first level and the particular level assigned to the user in the hierarchical tree. Thus, in an embodiment, a highest discount may be assigned to users that are highest in the tree hierarchy (e.g., in the set of initial group members), with a progressively lower discount being assigned to users progressively further down (at lower levels) in the tree hierarchy. The determined discount values for each user may be output by tree position-based discount determiner 802 in determined discounts 618, as shown in FIG. 8.

For example, referring to FIG. 10, user 1002 in the first level may be assigned the highest discount value. In an embodiment, this highest discount value may be used as a baseline to determine the other discount values. For instance, users 1004 and 1006 in the second level may be assigned a discount level that is lower than the highest discount value. In an embodiment, the discount level assigned to users 1004 and 1006 may be equal to the highest discount value multiplied by a first scaling factor having a value that is less than 1. Users 1008, 1010, and 1012 in the third level may be assigned a discount level that is lower than the discount value assigned to users in the second level. In an embodiment, the discount level assigned to users 1008, 1010, and 1012 may be equal to the highest discount value multiplied by a second scaling factor having a value that is less than the first scaling factor. Users 1014, 1016, 1018, and 1020 in the fourth level may be assigned a discount level that is lower than the discount value assigned to users in the third level. In an embodiment, the discount level assigned to users 1014, 1016, 1018, and 1020 may be equal to the highest discount value multiplied by a third scaling factor having a value that is less than the second scaling factor. Users 1022 and 1024 in the fifth level may be assigned a discount level that is lower than the discount value assigned to users in the fourth level. In an embodiment, the discount level assigned to users 1022 and 1024 may be equal to the highest discount value multiplied by a fourth scaling factor having a value that is less than the third scaling factor

It is noted that the discounts assigned to users in the different levels may be set and/or calculated in any manner relative to each other. In some alternative embodiments, users in different levels may be assigned the same discount. Furthermore, users in the higher levels (e.g., the first level) may be assigned discounts that are lower than discounts assigned to users in lower levels.

### 2. Example Embodiments for Determining Discounts According to User Participation Scores

In an embodiment, participation score determiner 804 and user participation score-based discount determiner 806 may be present in differential discount determiner 800. When present, participation score determiner 804 may be configured to calculate a participation score for each user partaking in a deal. The calculated participation score for a user is representative of how active the user is in the group. The more active that the user is, the higher the participation score, and the less active that the user is, the lower the participation score. Furthermore, user participation score-based discount determiner 806 is configured to calculate discounts for users of a group that are participating in a deal based on the calculated participation scores.

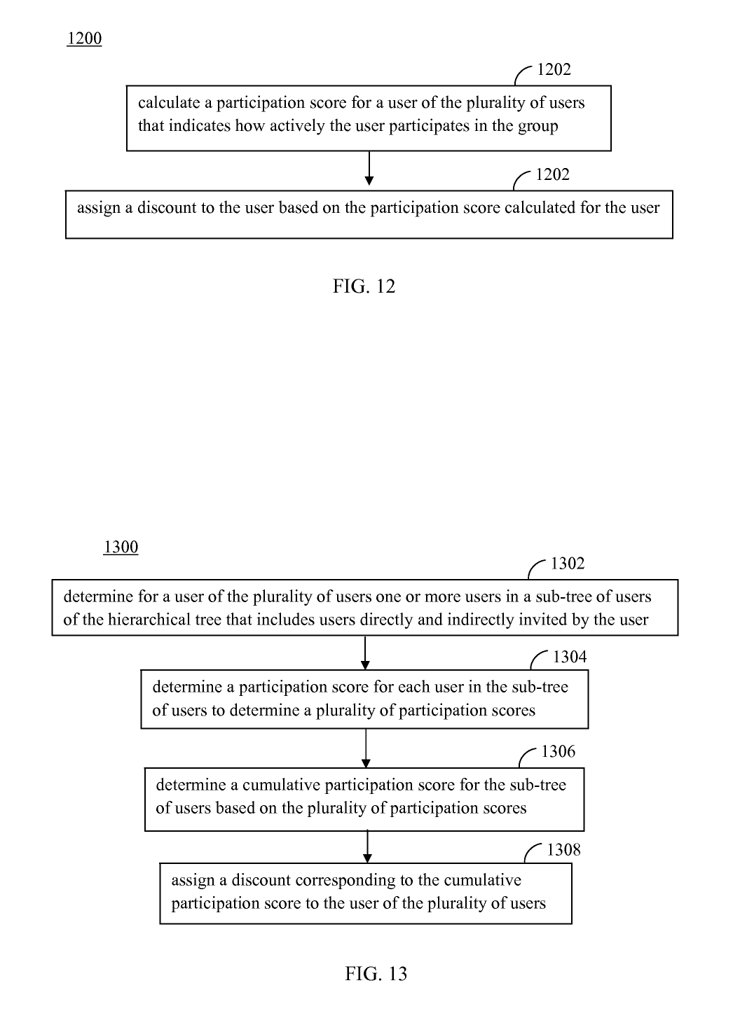

For instance, FIG. 12 shows a flowchart 1200 providing a process for assigning a discount to a user based on a participation score, according to an example embodiment. A discount may be calculated by participation score determiner 804 and user participation score-based discount determiner 806 according to flowchart 1200 for each user partaking in a deal.

In step 1202 of flowchart 1200, a participation score is calculated for a user of the plurality of users that indicates how actively the user participates in the group. In an embodiment, participation score determiner 804 calculates a participation score for a user that indicates how active the user is in the group. For instance, as described above, tracking information 322 may include information regarding content provided by users to the group. For instance, tracking information 322 may indicate a number of times users have provided content to the group (e.g., a number of messages provided to the group, a number of images provided to the group). Furthermore, tracking information 322 may indicate how popular the provided content has been found to be by the group. For instance, tracking information 322 may indicate whether (and how many) users have “liked” the provided content, how many users have provided favorable or unfavorable reviews of the provided content, etc. Participation score determiner 804 may calculate a participation score for the user based on this tracked information in any manner. For instance, a number of times the user provided content to the group may be multiplied by a quality factor that reflects a popularity of the provided content to generate a raw participation score. This raw participation score may be multiplied by a normalizing factor so that the resulting participation score is a value in the range of 0 to 1 (or other range).

Note that this example technique for calculating a participation score is provided for purposes of illustration, and is not intended to be limiting. Further techniques for calculating a participation score will be apparent to persons skilled in the relevant art(s) from the teachings herein. Such techniques may use one or more of any combination of scaling factors, numbers of provided content, quality of provided content, etc., to determine participation scores for users.

In step 1204, a discount to the user based on the participation score calculated for the user. In an embodiment, user participation score-based discount determiner 806 calculates a discount for a user based on the participation score calculated by participation score determiner 804 for the user. For instance, in an embodiment, user participation score-based discount determiner 806 may have a baseline discount value to provide to users of the group. User participation score-based discount determiner 806 may multiply the baseline discount value by the participation score calculated for the user to determine the discount for the user. The determined discount values for each user may be output by user participation score-based discount determiner 806 in determined discounts 618, as shown in FIG. 8.

For instance, in one example, the baseline discount value for a deal may be 20%. A first user may have a participation score of 0.8 (e.g., relatively high participation), while a second user may have a participation score of 0.3 (e.g., relatively low participation). In such an example, user participation score-based discount determiner 806 may calculate a discount for the first user of 20%×0.8=16%, and may calculate a discount value for the second user of 20%×0.3=6%.

Note that this example technique for calculating a discount by multiplying a baseline discount value by the participation score is provided for purposes of illustration, and is not intended to be limiting. Further techniques for calculating a discount based on a participation score will be apparent to persons skilled in the relevant art(s) from the teachings herein. Such techniques may use one or more of any combination of scaling factors, baseline discount values, etc., in combination with participation scores to calculate discount values for users.

### 3. Example Embodiments for Determining Discounts According to Sub-Tree Factors

In an embodiment, sub-tree participation score-based discount determiner 808 may be present in differential discount determiner 800. When present, sub-tree participation score-based discount determiner 808 may be configured to calculate a discount for each user partaking in a deal. Group participation scores may be calculated by participation score determiner 804 for all users in the group tree hierarchy. A cumulative participation score may be determined for the user based on the participation scores of the users in the group tree hierarchy that were directly and indirectly invited to the group by the user. The discount value for the user may be calculated by sub-tree participation score-based discount determiner 808 based on the cumulative participation score.

For instance, FIG. 13 shows a flowchart 1300 providing a process for assigning a discount to a user based on a sub-tree of users in the group hierarchy directly and indirectly invited by the user to the group, according to an example embodiment. A discount may be calculated by participation score determiner 804 and sub-tree participation score-based discount determiner 808 according to flowchart 1300 for each user partaking in a deal.

In step 1302 of flowchart 1300, determine for a user of the plurality of users one or more users in a sub-tree of users of the hierarchical tree that includes users directly and indirectly invited by the user. For instance, as described above, a tree hierarchy may be determined for a group that reflects which users invited which other users to the group. Such a tree hierarchy may be determined from tracking information 322. Tree hierarchy 1000 of FIG. 10 is an example of such a tree hierarchy. In an embodiment, sub-tree participation score-based discount determiner 808 may be configured to analyze a tree hierarchy to determine which users were directly or indirectly invited to a group by a user. “Directly invited users” for a user are users that were sent an invitation to join the group from the user. “Indirectly invited users” for a user are users that the user did not send an invitation to join the group, but that were sent invitations by other users of the group that are in the group due to the user—are present in a branch of the tree hierarchy below the user that connects to the user through a chain of branches.

For instance, referring to FIG. 10, user 1012 has a sub-tree of directly and indirectly invited users of users 1020, 1022, and 1024, user 1004 has a sub-tree of directly and indirectly invited users of users 1008, 1010, 1014, 1016, and 1018, etc.

In step 1304, a participation score is determined for each user in the sub-tree of users to determine a plurality of participation scores. In an embodiment, participation score determiner 804 may be configured to determine a participation score for each user in the sub-tree of the user in a manner as described above (e.g., with respect to step 1202 of FIG. 12).

In step 1306, a cumulative participation score is determined for the sub-tree of users based on the plurality of participation scores. In an embodiment, sub-tree participation score-based discount determiner 808 may receive the participation scores for the users in the sub-tree of the user from participation score determiner 804. Sub-tree participation score-based discount determiner 808 may generate a cumulative participation score from the received participation scores in any manner. For instance, in one embodiment, sub-tree participation score-based discount determiner 808 may add together the participation scores for all of the users in the sub-tree to generate a sum, and may apply a normalizing factor to the cumulative participation score so that it has a value in the range of 0 to 1 (or other range). In other embodiments, sub-tree participation score-based discount determiner 808 may generate a cumulative participation score based on participation scores of users in the sub-tree of a user in other ways.

In step 1308, a discount corresponding to the cumulative participation score is assigned to the user of the plurality of users. In embodiments, sub-tree participation score-based discount determiner 808 calculates a discount for a user based on the cumulative participation score. For instance, in an embodiment, sub-tree participation score-based discount determiner 808 may have a baseline discount value to provide to users of the group. Sub-tree participation score-based discount determiner 808 may multiply the baseline discount value by the cumulative participation score calculated for the user to determine the discount for the user. The determined discount values for each user may be output by sub-tree participation score-based discount determiner 808 in determined discounts 618, as shown in FIG. 8.

Note that this example technique for calculating a discount by multiplying a baseline discount value by the cumulative participation score is provided for purposes of illustration, and is not intended to be limiting. Further techniques for calculating a discount based on a cumulative participation score will be apparent to persons skilled in the relevant art(s) from the teachings herein. Such techniques may use one or more of any combination of scaling factors, baseline discount values, etc., in combination with baseline participation scores to calculate discount values for users.

### 4. Example Embodiments for Determining Discounts According to Group Characteristics

In an embodiment, group-based discount determiner 810 may be present in differential discount determiner 800. When present, group-based discount determiner 810 may be configured to calculate a baseline discount value for a group. The baseline discount value may be used as a discount for all users in the group, or may be used as a baseline from which differential discount values may be determined for the users of the group (e.g., as described elsewhere herein). The baseline discount value for the group may be set higher or lower relative to other groups based on various factors.

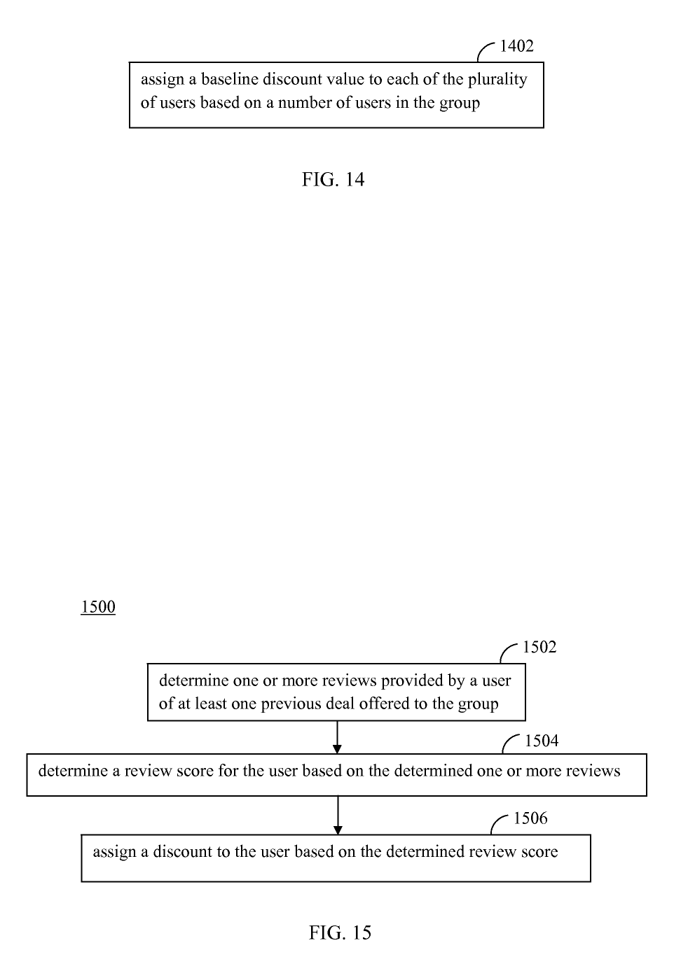

For instance, FIG. 14 shows a process 1402 for assigning a discount to users in a group based on a size of the group, according to an example embodiment. In process 1402, a baseline discount value is assigned to each of the plurality of users based on a number of users in the group. In an embodiment, group-based discount determiner 810 is configured to assign a baseline discount value to a group, such that each user in the group has the same baseline discount value, based on a total number of users in the group.

For example, in an embodiment, group-based discount determiner 810 may determine a total number of users in a group. For instance, the number of users in the group may be indicated in tracking information 322. Based on the total number of users in the group, group-based discount determiner 810 may assign a corresponding baseline discount value to the group. For relatively larger groups having larger numbers of users, a greater discount value may be assigned as the baseline discount value. For medium sized groups having a relatively medium numbers of users, a medium discount value may be assigned as the baseline discount value. For relatively smaller groups having lower numbers of users, a lower discount value may be assigned as the baseline discount value.

If differential discount values are determined for the group, the baseline discount value determined by group-based discount determiner 810 may be used as the group baseline discount value from which to determine differential discount values for the users. If each user of the group is assigned the baseline discount value determined by group-based discount determiner 810 (i.e., differential discount values are not determined), this baseline discount value may be output for all users of the group in determined discounts 618, as shown in FIG. 8.

### 5. Example Embodiments for Determining Discounts According to Provided Reviews

In an embodiment, review-based discount determiner 812 may be present in differential discount determiner 800. When present, review-based discount determiner 812 may be configured to calculate a review score for each user partaking in a deal. The calculated review score for a user is representative of a quantity and/or quality of previous reviews provided to the group by the user of previously offered deals. For instance, the more reviews that the user provides, the higher the potential review score, and the fewer reviews that the user provides, the lower the potential review score. Furthermore, review-based discount determiner 812 is configured to calculate discounts for users of a group that are participating in a deal based on the calculated review scores.

For instance, FIG. 15 shows a flowchart 1500 providing a process for assigning a discount to a user based on reviews provided by the user of at least one offer previously provided to the group, according to an example embodiment. A discount may be calculated by review-based discount determiner 812 according to flowchart 1500 for each user partaking in a deal.

In step 1502 of flowchart 1500, one or more reviews provided by a user of at least one previous deal offered to the group are determined. In an embodiment, review-based discount determiner 812 calculates a review score for a user that indicates a quantity and/or quality of reviews provided by the user of deals previously offered to the group. For instance, as described above, tracking information 322 may include information regarding content provided by users to the group. Such tracking information 322 may indicate a number of times users have provided reviews to the group (e.g., whether the user liked or disliked the previously offered deal, why the user like or disliked the previously offered deal, etc.). Furthermore, tracking information 322 may indicate how popular the provided reviews were found to be by the group (e.g., a quality of the reviews). For instance, tracking information 322 may indicate whether (and how many) users have “liked” the provided reviews, how many users have provided favorable or unfavorable comments on the provided reviews, how many users have forwarded the reviews to other users, etc.

In step 1504, a review score for the user is determined based on the determined one or more reviews. In an embodiment, review-based discount determiner 812 may calculate a review score for the user based on the above-described review quantity and/or quality information in any manner. For instance, a number of times the user provided reviews to the group may be multiplied by a quality factor that reflects a popularity of the provided reviews to generate a raw review score. This raw review score may be multiplied by a normalizing factor so that the resulting review score is a value in the range of 0 to 1 (or other range).

Note that this example technique for calculating a review score is provided for purposes of illustration, and is not intended to be limiting. Further techniques for calculating a review score will be apparent to persons skilled in the relevant art(s) from the teachings herein. Such techniques may use one or more of any combination of scaling factors, numbers of provided reviews, quality of provided reviews, etc., to determine review scores for users.

In step 1506, a discount is assigned to the user based on the determined review score. In an embodiment, review-based discount determiner 812 calculates a discount for a user based on the review score of the user. For instance, in an embodiment, review-based discount determiner 812 may have a baseline discount value to provide to users of the group. Review-based discount determiner 812 may multiply the baseline discount value by the review score calculated for the user to determine the discount for the user. The determined discount values for each user may be output by review-based discount determiner 812 in determined discounts 618, as shown in FIG. 8.

Note that this example technique for calculating a discount by multiplying a baseline discount value by the review score is provided for purposes of illustration, and is not intended to be limiting. Further techniques for calculating a discount based on a review score will be apparent to persons skilled in the relevant art(s) from the teachings herein. Such techniques may use one or more of any combination of scaling factors, baseline discount values, etc., in combination with review scores to calculate discount values for users.

### C. Further Example Embodiments and Advantages

Various embodiments are described herein for forming user groups, offering deals to user groups, and determining discount values for users. In an embodiment, when a dynamic group is formed, a group creator/owner may send out invites to his/her friends/contacts. These friends in turn send out the invites to their circles. As the group size grows, a hierarchy based on the “invites” may be formed. Every member of the group has a single parent user, depending on whose invite the member accepted. By inviting participants to a group who add real value to the theme of the group (e.g., by creating/sharing content, discussions, reviews etc.), the parent user is considered to have contributed to the overall strength of the group. Thus, in embodiments, parent users may be rewarded for the performance of their children users (invitees) with greater discounts.

In embodiments, such as the embodiments described above, differential deals may be provided based on at least the following parameters:

1. Better deals (e.g., greater discounts) may be given to group members who have larger sub-trees. The higher up a user is in a tree of members, the better the deals that are offered to the user.

2. Better deals may be given to group members who have a better “participation score.” The more active a user is in a group, the better the theme-based deals (better discounts) offered to the user. This creates an incentive for group members to participate actively and create content that receives better reviews.

3. Better deals may be offered to group members whose sub-tree's cumulative participation-score is higher.

4. Better deals may be offered to groups (i.e., to every group member) that have larger size. This may incentivize smaller groups having a similar theme/topic to a larger group to merge into the larger group, which may result in more network effects, better engagement, and thus cheaper and more targeted deals to be offered to the merged group.

5. Better deals may be given to users who write substantial and/or popular reviews for previously offered deals. This creates network-effects within a group and feeds into the chances for successful deal consumption.

Differential discounts are not limited to the above mentioned incentive parameters.

Differential discounts provide a virtuous cycle—better engagement with the group means better deals, and better deals incentivize better engagement with the group—this can be used in a very productive manner by an entity that provides a deal offering system to provide an engaging system.

Furthermore, participants in a deal may be enabled to review the deal once they have availed the deal. This leads to network-effects within a theme-based group which further popularizes a particular deal. All of this leads to a better chance that a deal is accepted by potential customers.

Still further, deals are enabled to reach the right audience (e.g., having a theme/topic that pairs well with a particular deal) at the right discount level.

Furthermore, embodiments reduce the chances that an irrelevant deal is pushed to a user. As such, more and more deals can be designed in a manner such that every deal reaches a more relevant audience.

Still further, the entity that hosts a deal system may be enabled to receive a better revenue-share from deal-providers (e.g., receiving a greater percentage or other cut from a deal offered by a deal providing merchant that is accepted by a group) as they are able to provide deals to a more focused audience (e.g., user groups having relevant topics/themes for particular deals).

### III. Example Computer Implementations

Group management system 118, differential deal offering system 120, group configuration module 302, user invitation module 304, content interface module 306, group tracker 308, differential deal offering system 600, deal offering engine 602, differential discount determiner 604, differential discount determiner 800, tree position-based discount determiner 802, participation score determiner 804, user participation score-based discount determiner 806, sub-tree participation score-based discount determiner 808, group-based discount determiner 810, review-based discount determiner 812, flowchart 200, flowchart 500, process 900, flowchart 1100, flowchart 1200, flowchart 1300, process 1402, flowchart 1500, and/or any further systems, sub-systems, and/or components disclosed herein may be implemented in hardware, or any combination of hardware with software and/or firmware. For example, group management system 118, differential deal offering system 120, group configuration module 302, user invitation module 304, content interface module 306, group tracker 308, differential deal offering system 600, deal offering engine 602, differential discount determiner 604, differential discount determiner 800, tree position-based discount determiner 802, participation score determiner 804, user participation score-based discount determiner 806, sub-tree participation score-based discount determiner 808, group-based discount determiner 810, review-based discount determiner 812, flowchart 200, flowchart 500, process 900, flowchart 1100, flowchart 1200, flowchart 1300, process 1402, and/or flowchart 1500 may be implemented as computer program code configured to be executed in one or more processors. Alternatively, group management system 118, differential deal offering system 120, group configuration module 302, user invitation module 304, content interface module 306, group tracker 308, differential deal offering system 600, deal offering engine 602, differential discount determiner 604, differential discount determiner 800, tree position-based discount determiner 802, participation score determiner 804, user participation score-based discount determiner 806, sub-tree participation score-based discount determiner 808, group-based discount determiner 810, review-based discount determiner 812, flowchart 200, flowchart 500, process 900, flowchart 1100, flowchart 1200, flowchart 1300, process 1402, and/or flowchart 1500 may be implemented as hardware logic/electrical circuitry.

Storage 620 (FIG. 6) may each include one or more of any type of storage mechanism to store resources, including a magnetic disk (e.g., in a hard disk drive), an optical disc (e.g., in an optical disk drive), a magnetic tape (e.g., in a tape drive), a memory device such as a RAM device, a ROM device, etc., and/or any other suitable type of storage medium.

As described above, group management systems and differential deal offering systems may generate one or more user interfaces. For instance, group management systems and differential deal offering systems may enable user input to be provided from one or more of any type of user interface elements provided by a computing device, including a keyboard, a thumb wheel, a pointing device, a roller ball, a stick pointer, a touch sensitive display, any number of virtual interface elements, a voice recognition system, etc. Graphical user interfaces (GUI) may be displayed in a display of the computing device, such as in a browser window generated by a web browser, an application window, or in other window type mentioned elsewhere herein or otherwise known.

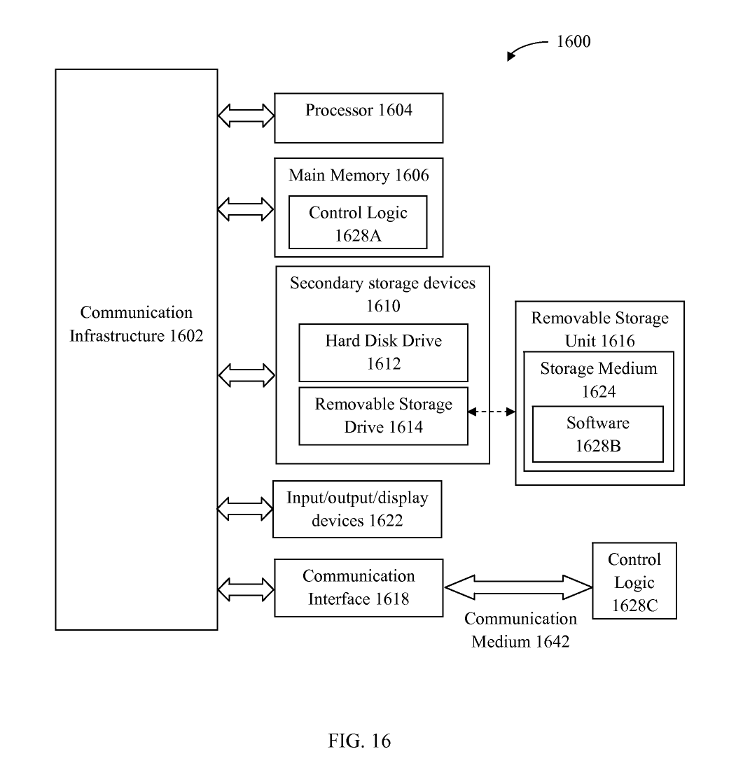

The embodiments described herein, including systems, methods/processes, and/or apparatuses, may be implemented using well known servers/computers, such as a computer 1600 shown in FIG. 16. For example, server 102, user devices 104, 106, 108, and 110, merchant devices 112 and 114, and any of the sub-systems or components contained therein may be implemented using one or more computers 1600.

Computer 1600 can be any commercially available and well known computer capable of performing the functions described herein, such as computers available from International Business Machines, Apple, Sun, HP, Dell, Cray, etc. Computer 1600 may be any type of computer, including a desktop computer, a server, etc.

Computer 1600 includes one or more processors (also called central processing units, or CPUs), such as a processor 1604. Processor 1604 is connected to a communication infrastructure 1602, such as a communication bus. In some embodiments, processor 1604 can simultaneously operate multiple computing threads.

Computer 1600 also includes a primary or main memory 1606, such as random access memory (RAM). Main memory 1606 has stored therein control logic 1628A (computer code or instructions), and data.

Computer 1600 also includes one or more secondary storage devices 1610. Secondary storage devices 1610 include, for example, a hard disk drive 1612 and/or a removable storage device or drive 1614, as well as other types of storage devices, such as memory cards and memory sticks. For instance, computer 1600 may include an industry standard interface, such a universal serial bus (USB) interface for interfacing with devices such as a memory stick. Removable storage drive 1614 represents a floppy disk drive, a magnetic tape drive, a compact disk drive, an optical storage device, tape backup, etc.

Removable storage drive 1614 interacts with a removable storage unit 1616. Removable storage unit 1616 includes a computer useable or readable storage medium 1624 having stored therein computer logic 1628B (computer instructions or code) and/or data. Removable storage unit 1616 represents a floppy disk, magnetic tape, compact disk, DVD, optical storage disk, or any other computer data storage device. Removable storage drive 1614 reads from and/or writes to removable storage unit 1616 in a well-known manner.

Computer 1600 also includes input/output/display devices 1622, such as monitors, keyboards, pointing devices, etc.

Computer 1600 further includes a communication or network interface 1618. Communication interface 1618 enables computer 1600 to communicate with remote devices. For example, communication interface 1618 allows computer 1600 to communicate over communication networks or mediums 1642 (representing a form of a computer useable or readable medium), such as LANs, WANs, the Internet, etc. Network interface 1618 may interface with remote sites or networks via wired or wireless connections.

Control logic 1628C may be transmitted to and from computer 1600 via the communication medium 1642.

Any apparatus or manufacture comprising a computer useable or readable medium (e.g., a computer-readable storage or recording medium) having control logic (computer instructions or code) stored therein is referred to herein as a computer program product or program storage device. This includes, but is not limited to, computer 1600, main memory 1606, secondary storage devices 1610, and removable storage unit 1616. Such computer program products, having control logic stored therein that, when executed by one or more data processing devices, cause such data processing devices to operate as described herein, represent embodiments of the invention.

Devices in which embodiments may be implemented may include storage, such as storage drives, memory devices, and further types of computer-readable media. Examples of such computer-readable storage media (computer-readable recording media) include a hard disk, a removable magnetic disk, a removable optical disk, flash memory cards, digital video disks, random access memories (RAMs), read only memories (ROM), and the like. As used herein, the terms “computer program medium” and “computer-readable medium” are used to generally refer to the hard disk associated with a hard disk drive, a removable magnetic disk, a removable optical disk (e.g., CDROMs, DVDs, etc.), zip disks, tapes, magnetic storage devices, MEMS (micro-electromechanical systems) storage, nanotechnology-based storage devices, as well as other media such as flash memory cards, digital video discs, RAM devices, ROM devices, and the like. Such computer-readable storage media may store program modules that include computer program logic for implementing group management system 118, differential deal offering system 120, group configuration module 302, user invitation module 304, content interface module 306, group tracker 308, differential deal offering system 600, deal offering engine 602, differential discount determiner 604, differential discount determiner 800, tree position-based discount determiner 802, participation score determiner 804, user participation score-based discount determiner 806, sub-tree participation score-based discount determiner 808, group-based discount determiner 810, review-based discount determiner 812, flowchart 200, flowchart 500, process 900, flowchart 1100, flowchart 1200, flowchart 1300, process 1402, and/or flowchart 1500 (including any step of flowcharts 200, 500, 1100, 1200, 1300, and 1500), and/or further embodiments described herein. Embodiments of the invention are directed to computer program products comprising such logic (e.g., in the form of program code or instructions) stored on any computer useable medium. Such program code, when executed in one or more processors, causes a device to operate as described herein.

Note that such computer-readable storage media are distinguished from and non-overlapping with communication media (do not include communication media). Communication media typically embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media. Embodiments are also directed to such communication media.

The invention can work with hardware, combinations of hardware with software/firmware, and/or operating system implementations other than those described herein. Any such implementations suitable for performing the functions described herein can be used.

### IV. Conclusion

While various embodiments have been described above, it should be understood that they have been presented by way of example only, and not limitation. It will be apparent to persons skilled in the relevant art(s) that various changes in form and details can be made therein without departing from the spirit and scope of the invention. Thus, the breadth and scope of the present invention should not be limited by any of the above-described exemplary embodiments, but should be defined only in accordance with the following claims and their equivalents.

1. A method comprising:
communicating, via a computing device over a network, a deal to users of a group of users, the group formed in association with a corresponding topic;
enabling, via the computing device, each user of the group to selectively accept the deal;
confirming, via the computing device, the deal with a plurality of users of the group that accepted the deal; and
differentially assigning, via the computing device, discounts for the deal to the plurality of users based on at least one parameter of the deal such that at least two users of the plurality of users that accepted the deal have discounts for the deal that are different from each other.

2. The method of claim 1, wherein said differentially assigning discounts for the deal to the plurality of users based on at least one parameter comprises:
assigning a discount to a user of the plurality of users based on a position of the user in a hierarchical tree of users of the group.

3. The method of claim 2, wherein the hierarchical tree of users of the group includes one or more users that are initial group members and a remaining set of one or more users that does not include the initial group members, each user of the remaining set having been invited to the group by another user of the group; and
wherein said assigning a discount to a user of the plurality of users based on a position of the user in a hierarchical tree of users of the group comprises:
determining a position of the user in the hierarchical tree of users of the group by
assigning the user to a first level in the hierarchical tree if the user is one of the initial group members, and
if the user is not one of the initial group members, assigning the user to a subsequent level in the hierarchical tree corresponding to a number of users that separate the user from the initial group members in a chain of user invitations to the group; and
assigning the discount to the user based on a particular level in the hierarchical tree assigned to the user.

4. The method of claim 3, wherein said assigning the discount to the user based on a particular level in the hierarchical tree assigned to the user comprises:
assigning a highest discount to the user if the particular level assigned to the user is the first level; and
if the particular level assigned to the user is not the first level, assigning a discount to the user that is lower than the highest discount by an amount proportional to a separation of the first level and the particular level assigned to the user in the hierarchical tree.

5. The method of claim 1, wherein said differentially assigning discounts for the deal to the plurality of users based on at least one parameter comprises:
assigning a discount to a user of the plurality of users based on a participation score for the user that indicates how actively the user participates in the group.

6. The method of claim 1, wherein the users in the group form a hierarchical tree of users that includes one or more users that are initial group members and a remaining set of one or more users that does not include the initial group members, each user of the remaining set having been invited to the group by another user of the group; and
wherein said differentially assigning discounts for the deal to the plurality of users based on at least one parameter comprises:
determining for a user of the plurality of users one or more users in a sub-tree of users of the hierarchical tree that includes users directly and indirectly invited by the user to the group;
determining a participation score for each user in the sub-tree of users to determine a plurality of participation scores;
determining a cumulative participation score for the sub-tree of users based on the plurality of participation scores; and
assigning a discount to the user corresponding to the cumulative participation score.

7. The method of claim 1, further comprising:
assigning a baseline discount value to each of the plurality of users based on a number of users in the group.

8. The method of claim 1, wherein said differentially assigning discounts for the deal to the plurality of users based on at least one parameter comprises:
determining one or more reviews provided by a user of the plurality of users of at least one deal previously offered to the group;
determining a review score for the user based on the determined one or more reviews; and
assigning a discount to the user based on the determined review score.

9. A differential deal offering system comprising:
a plurality of processors;
a discount offering engine implemented by at least one of said plurality of processors that communicates a deal to users of a group of users formed in association with a corresponding topic, enables each user of the group to selectively accept the deal, and confirms the deal with a plurality of users of the group that accepted the deal; and
a differential discount determiner implemented by at least one of said plurality of processors that differentially assigns discounts for the deal to the plurality of users based on at least one parameter of the deal such that at least two users of the plurality of users that accepted the deal have discounts for the deal that are different from each other.

10. The differential deal offering system of claim 9, wherein the differential discount determiner includes a tree position-based discount determiner; and
wherein the tree position-based discount determiner assigns a discount to a user of the plurality of users based on a position of the user in a hierarchical tree of users of the group.

11. The differential deal offering system of claim 10, wherein the hierarchical tree of users of the group includes one or more users that are initial group members and a remaining set of one or more users that does not include the initial group members, each user of the remaining set having been invited to the group by another user of the group;
wherein the tree position-based discount determiner assigns the user to a first level in the hierarchical tree if the user is one of the initial group members, and if the user is not one of the initial group members, assigns the user to a subsequent level in the hierarchical tree corresponding to a number of users that separate the user from the initial group members in a chain of user invitations to the group; and
wherein the tree position-based discount determiner assigns the discount to the user based on a particular level in the hierarchical tree assigned to the user.

12. The differential deal offering system of claim 11, wherein the tree position-based discount determiner assigns a highest discount to the user if the particular level assigned to the user is the first level; and
if the particular level assigned to the user is not the first level, the tree position-based discount determiner assigns a discount to the user that is lower than the highest discount by an amount proportional to a separation of the first level and the particular level assigned to the user in the hierarchical tree.

13. The differential deal offering system of claim 9, wherein the differential discount determiner includes a user participation score-based discount determiner and a participation score determiner;
wherein the user participation score determiner determines a participation score for a user of the plurality of users that indicates how actively the user participates in the group; and
wherein the user participation score-based discount determiner assigns a discount to the user based on the participation score.

14. The differential deal offering system of claim 9, wherein the users in the group form a hierarchical tree of users that includes one or more users that are initial group members and a remaining set of one or more users that does not include the initial group members, each user of the remaining set having been invited to the group by another user of the group;
wherein the differential discount determiner includes a sub-tree participation score-based discount determiner and a participation score determiner;
wherein the sub-tree participation score-based discount determiner determines for a user of the plurality of users one or more users in a sub-tree of users of the hierarchical tree that includes users directly and indirectly invited by the user to the group;
wherein the participation score determiner determines a participation score for each user in the sub-tree of users to determine a plurality of participation scores; and
wherein the sub-tree participation score-based discount determiner determines a cumulative participation score for the sub-tree of users based on the plurality of participation scores, and assigns a discount to the user corresponding to the cumulative participation score.

15. The differential deal offering system of claim 9, wherein the differential discount determiner includes a group-based discount determiner that assigns a baseline discount value to each of the plurality of users based on a number of users in the group.

16. The differential deal offering system of claim 9, wherein the differential discount determiner includes a review-based discount determiner that
determines one or more reviews provided by a user of the plurality of users of at least one deal previously offered to the group,
determines a review score for the user based on the determined one or more reviews, and
assigns a discount to the user based on the determined review score.

17. A non-transitory computer readable storage medium having computer program instructions embodied in said computer readable storage medium for enabling a processor to offer deals, the computer program instructions comprising:
first computer program instructions that cause the processor to communicate a deal to users of a group of users, the group formed in association with a corresponding topic;
second computer program instructions that cause the processor to differentially assign discounts for the deal to a plurality of users of the group of users that accepted the deal based on at least one parameter of the deal such that at least two users of the plurality of users that accepted the deal have discounts for the deal that are different from each other.

18. The non-transitory computer readable storage medium of claim 17, wherein said second computer program instructions comprise:
third computer program instructions that cause the processor to assign a discount to a user of the plurality of users based on a position of the user in a hierarchical tree of users of the group.

19. The non-transitory computer readable storage medium of claim 17, wherein said second computer program instructions comprise:
third computer program instructions that cause the processor to assign a discount to a user of the plurality of users based on a participation score for the user that indicates how actively the user participates in the group.

20. The non-transitory computer readable storage medium of claim 17, wherein the users in the group form a hierarchical tree of users that includes one or more users that are initial group members and a remaining set of one or more users that does not include the initial group members, each user of the remaining set having been invited to the group by another user of the group; and
wherein said second computer program instructions comprise:
third computer program instructions that cause the processor to determine for a user of the plurality of users one or more users in a sub-tree of users of the hierarchical tree that includes users directly and indirectly invited by the user to the group; and
fourth computer program instructions that cause the processor to determine a participation score for each user in the sub-tree of users to determine a plurality of participation scores;
wherein the third computer program instructions cause the processor to determine a cumulative participation score for the sub-tree of users based on the plurality of participation scores, and enable the processor to assign a discount to the user corresponding to the cumulative participation score.

21. The non-transitory computer readable storage medium of claim 17, said second computer program instructions comprise:
third computer program instructions that cause the processor to
determine one or more reviews provided by a user of the plurality of users of at least one deal previously offered to the group,
determine a review score for the user based on the determined one or more reviews, and
assign a discount to the user based on the determined review score.
